(19) United States
(12) Patent Application Publication
(10) Pub. No.: US 2006/0017808 A1
(43) Pub. Date: Jan. 26, 2006

(54) Flame quality sensor

(76) Inventors: Peter H. Mahowald, Los Altos, CA (US); Pamela Lau Kee, Los Gatos, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/896,252

(22) Filed: Jul. 21, 2004

(51) Int. Cl. H04N 7/18; H04N 9/47

(52) U.S. Cl. 348/83

(57) ABSTRACT

A monitoring device includes an imager, a processor and transmission media. The imager is used to capture visual information pertaining to a flame produced by an appliance. The processor processes the visual information to produce processed information. The transmission media is used by the processor to forward the processed information to a monitoring system.

### BACKGROUND

In many applications, natural gas is used to supply fuel for flame in appliances such as water heaters, dryers, broilers, ovens and other appliances. For example, in applications such as recreational vehicles, flame from natural gas is used to produce power for refrigerators and air conditioners.

If the flame used for heat does not get proper oxygen, the flame turns from blue to yellow and a sooty deposit is created that lowers heating efficiency and can increase the amount of generated pollution.

Regular maintenance can detect the existence of an improperly burning flame. However, in many households, an interval of a year or more can occur between the performance of maintenance. Thus, a deficiency in operation resulting in a sub-optimal flame can be undetected for a long period of time. This can increase the cost of operating the appliance as well as result in the production of unnecessary pollution.

### SUMMARY OF THE INVENTION

In accordance with embodiments of the present invention, a monitoring device includes an imager, a processor and transmission media. The imager is used to capture visual information pertaining to a flame produced by an appliance. The processor processes the visual information to produce processed information. The transmission media is used by the processor to forward the processed information to a monitoring system.

### BRIEF DESCRIPTION OF THE DRAWINGS

FIG. 1 is a simplified block diagram showing operation of a flame quality sensor in accordance with an embodiment of the present invention.

FIG. 2 is a simplified block diagram of an image sensor in accordance with an embodiment of the present invention.

### DESCRIPTION OF THE EMBODIMENT

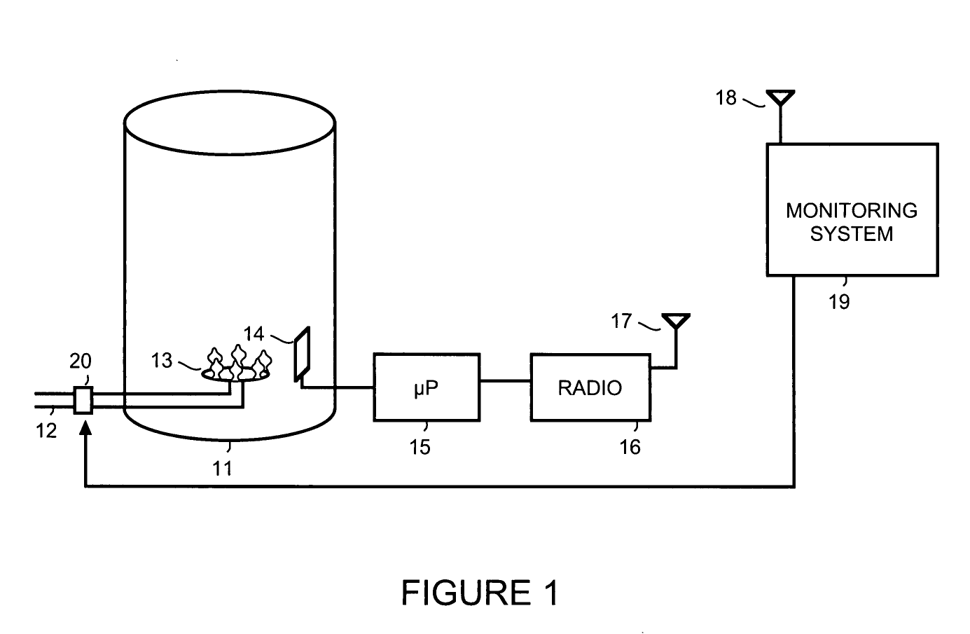

FIG. 1 is a simplified block diagram showing operation of a flame quality sensor in accordance with an embodiment of the present invention. A flame 13, within an appliance 11, is optically detected by an imager 14. A pipe 12 delivers gas that is fuel for flame 13. For example, appliance 11 is a water heater. Alternatively, appliance 11 is a dryer, a furnace, a broiler, an oven, a refrigerator, an air conditioner or another appliance that uses a flame.

A microprocessor (μP) 15 is used to process the image received from imager 14. The image produced by imager 14 can include, for example, information about color, brightness, and/or size of flame 13. Microprocessor 15 forwards the image information to a monitoring system 19, for example via a radio 16. For example, radio 16 uses an antenna 17 to transmit information to an antenna 18 of monitoring system 19. Alternatively, microprocessor 15 forwards the image information to a monitoring system 19 via other wireless, electrical or optical transmission media. For example, the electrical transmission media is wire. For example, the optical transmission media is fiber optic cable.

For example, microprocessor 15 passes a sufficient amount of the imaging information received from imager 14 to allow monitoring system 19 to reconstruct the entire image received by microprocessor 15 from imager 14. Alternatively, microprocessor 14 forwards to monitoring system 19 only a few bytes of information indicating, for example, color, brightness, and/or size of flame 13.

For example, monitoring system 19 uses a valve 20 to shut down the gas flow in pipe 12, extinguishing flame 13, when the quality of flame 13 degrades below a predetermined level. Alternatively, or in addition, monitoring system 19 sets off an alarm when the quality of flame 13 degrades below a predetermined level.

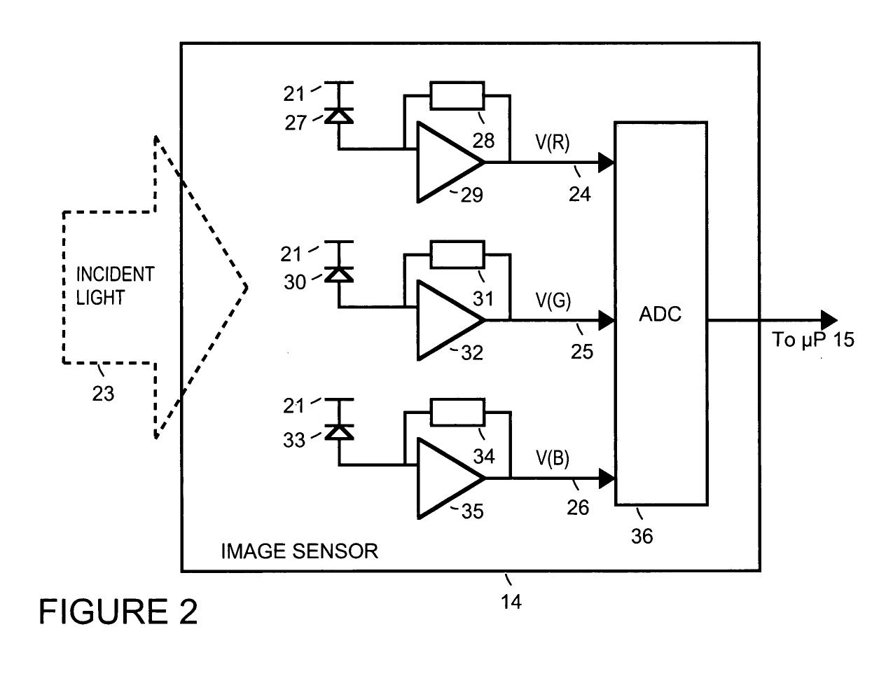

FIG. 2 is simplified block diagram of an embodiment of imager 14 implemented as a single color sensor that, for example, has a spectral measurement of wavelength from 400 nanometers (nm) to 700 nm. For example, the color sensor can be implemented as a complementary metal-oxide semiconductor (CMOS) image sensor.

In response to incident light 23, imager 14 generates three separate output voltages (V): a V(R) signal 24, a V(G) signal 25 and a V(B) signal 26. V(R) signal 24 is an analog signal that indicates the proportional red component of incident light 23 upon imager 14. For example, V(R) signal 24 is a DC voltage between 0 and 3 volts. V(G) signal 25 is an analog signal that indicates the proportional green component of incident light 23 upon imager 14. For example, V(G) signal 25 is a DC voltage between 0 and 3 volts. V(B) signal 26 is an analog signal that indicates the proportional blue component of incident light 23 upon imager 14. For example, V(B) signal 26 is a DC voltage between 0 and 3 volts.

V(R) signal 24 is generated by a photo sensor 27, an amplifier 29 and a feedback resistor 28, which are all located within imager 14. Photo sensor 27 includes an integrated color filter in red. Photo sensor 27 is connected to a power input signal 21.

V(G) signal 25 is generated by a photo sensor 30, an amplifier 32 and a feedback resistor 31, which are all located within imager 14. Photo sensor 30 includes an integrated color filter in green. Photo sensor 30 is connected to power input signal 21.

V(B) signal 26 is generated by a photo sensor 33, an amplifier 35 and a feedback resistor 34, which are all located within imager 14. Photo sensor 33 includes an integrated color filter in blue. Photo sensor 33 is connected to power input signal 21.

An analog-to-digital converter (ADC) 36 converts V(R) signal 24, V(G) signal 25 and V(B) signal 26 to a digital signal sent to microprocessor 15. The digital signal, for example, includes separate red, green and blue values.

Depending upon the imaging requirements, more sophisticated embodiments for imager 14 can be used. For example, if very accurate images are required, a charged coupled device (CCD) can be used for light-sensing. A CCD contains an array of photosensitive cells that react to incoming light based on the properties or the incoming light. The properties include, for example, intensity and color. The CCD captures incoming light via an optical lens and generates various analog signals that are converted to a DC signal utilized by microprocessor 15.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A method for monitoring quality of a flame, comprising:
capturing visual information pertaining to the flame utilizing an imager;
processing the visual information to produce processed information; and,
forwarding the processed information to a monitoring system.

2. A method as in claim 1 wherein the visual information comprises information indicating color of the flame.

3. A method as in claim 1 wherein the visual information comprises information indicating color and brightness of the flame.

4. A method as in claim 1 wherein the visual information comprises information indicating size of the flame.

5. A method as in claim 1 wherein the flame is within an appliance, the appliance being one of the following:
a water heater;
a dryer;
a furnace;
a broiler;
an oven;
a refrigerator;
an air conditioner.

6. A method as in claim 1 additionally comprising the following step:
when the monitoring system detects quality of the flame is degraded below a predetermined level, performing at least one of the following by the monitoring system:
shutting down the flame;
sounding an alarm.

7. A method as in claim 1 wherein the forwarding the processed information includes sending the processed information via one of the following:
wireless transmission;
wire-based electrical transmission;
optical transmission.

8. A monitoring device for use with an appliance, comprising:
an imager used to capture visual information pertaining to a flame produced by the appliance;
a processor that processes the visual information to produce processed information; and,
transmission media used by the processor to forward the processed information to a monitoring system.

9. A monitoring device as in claim 8 wherein the visual information comprises information indicating color of the flame.

10. A monitoring device as in claim 8 wherein the visual information comprises information indicating color and brightness of the flame.

11. A monitoring device as in claim 8 wherein the visual information comprises information indicating size of the flame.

12. A monitoring device as in claim 8 wherein the appliance is one of the following:
a water heater;
a dryer;
a furnace;
a broiler;
an oven;
a refrigerator;
an air conditioner.

13. A monitoring device as in claim 8 wherein the transmission media utilizes one of the following types of transmission:
wireless transmission;
wire-based electrical transmission;
optical transmission.

14. A monitoring device as in claim 8 wherein the imager comprises one of the following:
a charged coupled device;
a color sensor.

15. A monitoring device, comprising:
imager means for capturing visual information pertaining to a flame;
processing means for processing the visual information to produce processed information; and,
transmission means for transmitting the processed information from the processing means to a monitoring system.

16. A monitoring device as in claim 15 wherein the visual information comprises information indicating color and brightness of the flame.

17. A monitoring device as in claim 15 wherein the visual information comprises information indicating size of the flame.

18. A monitoring device as in claim 15 wherein the flame is produced by an appliance, the appliance being one of the following:
a water heater;
a dryer;
a furnace;
a broiler;
an oven;
a refrigerator;
an air conditioner.

19. A monitoring device as in claim 15 wherein the transmission means utilizes one of the following types of transmission:
wireless transmission;
wire-based electrical transmission;
optical transmission.

20. A monitoring device as in claim 15 wherein the imager means comprises one of the following:
a charged coupled device;
a color sensor.
